(19) United States
(12) Patent Application Publication
(10) Pub. No.: US 2026/0133379 A1
(43) Pub. Date: May 14, 2026

(54) OPTICAL DEVICE AND METHOD OF MANUFACTURE

(71) Applicant: Taiwan Semiconductor Manufacturing Co., Ltd., Hsinchu (TW)

(72) Inventors: Chia-Han Tsou, Hsinchu (TW); Ming-Fa Chen, Taichung City (TW)

(21) Appl. No.: 19/075,521

(22) Filed: Mar. 10, 2025

Related U.S. Application Data
(60) Provisional application No. 63/720,486, filed on Nov. 14, 2024.

(51) Int. Cl. G02B 6/42; G02B 6/36

(52) U.S. Cl. CPC G02B 6/4204; G02B 6/3636; G02B 6/4227; G02B 6/423; G02B 6/4239; G02B 6/4243

(57) ABSTRACT

Optical devices and methods of manufacture are presented in which a fiber array unit is connected to a first optical package. In embodiments the fiber array unit is passively aligned using a first projection and an opening and then actively aligned after being passively aligned. Once aligned, the fiber array unit is adhered using an adhesive.

### PRIORITY CLAIM AND CROSS-REFERENCE

This application claims the benefit of U.S. Provisional Application No. 63/720,486, filed on Nov. 14, 2024, which application is hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate formation of a first optical package, in accordance with some embodiments.

FIGS. 10A-10F illustrate an attachment of a fiber array unit to the first optical package, in accordance with some embodiments.

FIG. 11 illustrates another embodiment with a projection located on the first optical package, in accordance with some embodiments.

FIG. 12 illustrates another embodiment in which an opening is a series of trenches, in accordance with some embodiments.

FIG. 13 illustrates another embodiment in which an opening is a series of circular openings, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which a fiber array unit is connected with an optical package using both a passive alignment method as well as a an active alignment method, wherein the passive alignment further works to help prevent adhesion contamination on lenses located within the optical package. The embodiments presented, however, are intended to be illustrative and are not intended to limit the ideas presented to the precise embodiments described. Rather, the ideas presented may be incorporated into a wide variety of embodiments, and all such embodiments may be included within the overall scope of the disclosure.

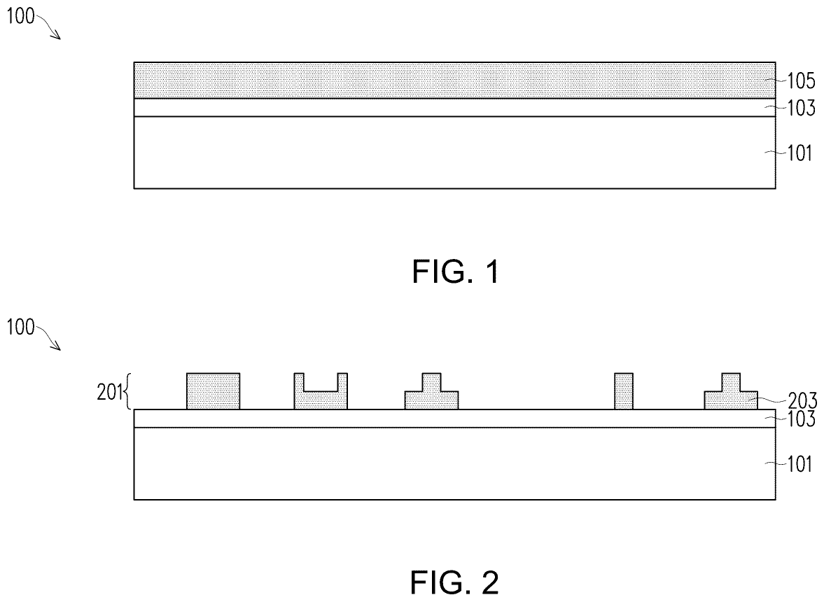

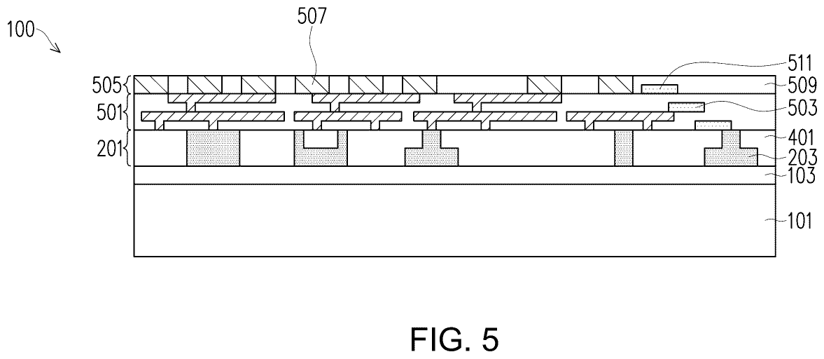

With reference now to FIG. 1, there is illustrated an initial structure of an optical interposer 100 (seen in FIG. 5), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the patterning process may be all or at least most of the manufacturing that is used to form these first optical components 203 components.

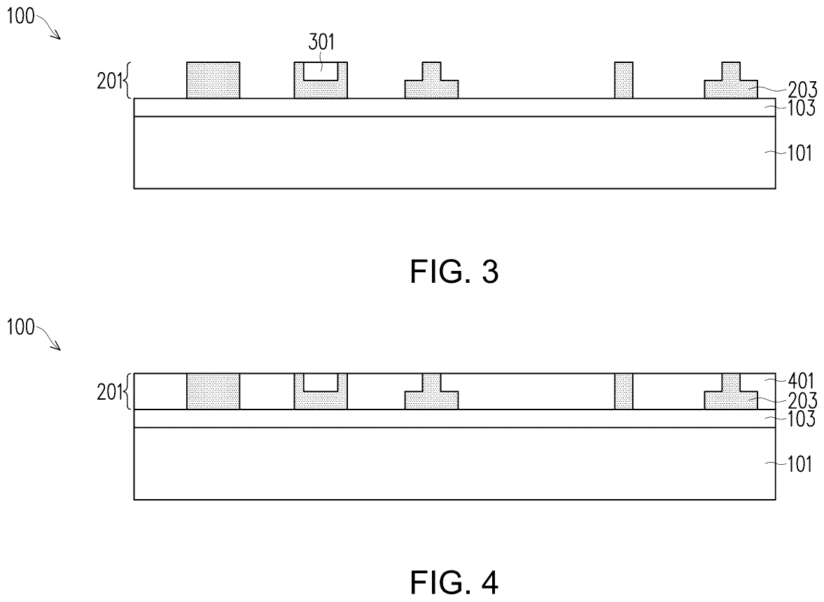

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

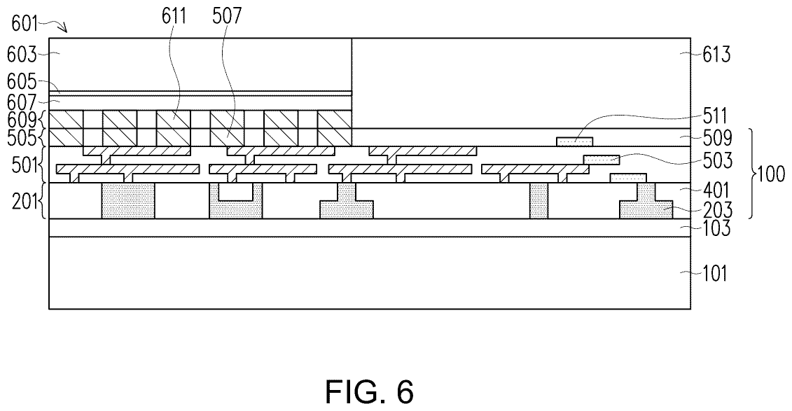

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the laser die 600. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a first gap-fill material 613 is deposited in order to fill the space around the first semiconductor device 601 and provide additional support. In an embodiment the first gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the first gap-fill material 613 has been deposited, the first gap-fill material 613 may be planarized in order to expose the first semiconductor device 601. In an embodiment the planarization process may be a chemical mechanical planarization process, a grinding process, or the like. However, any suitable planarization process may be utilized.

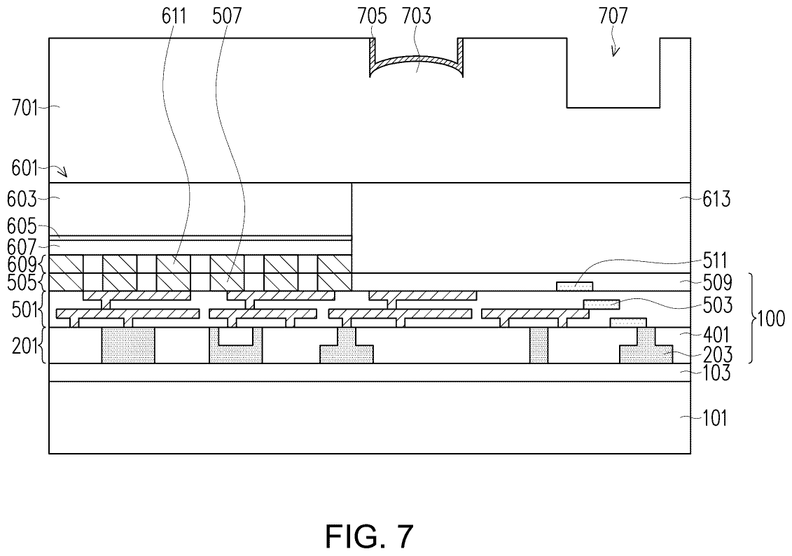

FIG. 7 illustrates an attachment of a support substrate 701 to the first semiconductor device 601 and the first gap-fill material 613. In an embodiment the support substrate 701 may be a support material that is transparent to the wavelength of light that is desired to be used, such as silicon, and may be attached using, e.g., an adhesive (not separately illustrated in FIG. 7). However, in other embodiments the support substrate 701 may be bonded to the first semiconductor device 601 and the first gap-fill material 613 using, e.g., a bonding process. Any suitable method of attaching the support substrate 701 may be used.

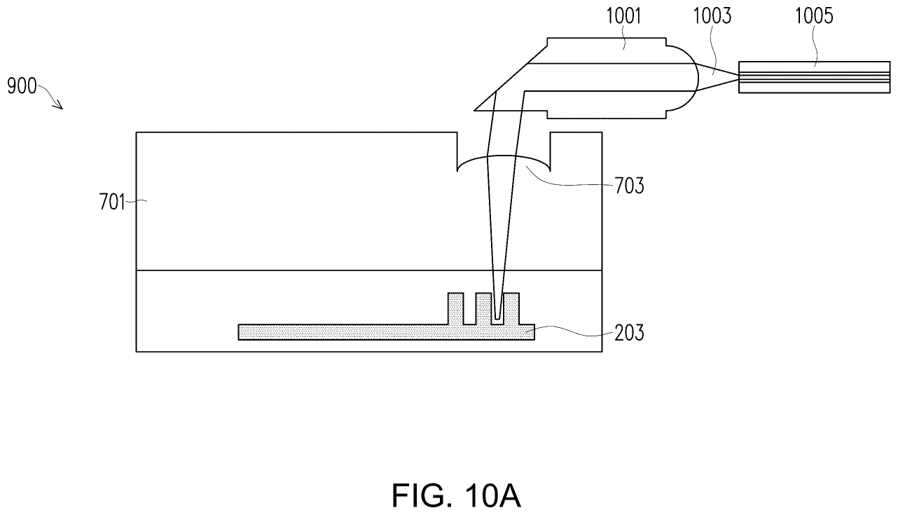

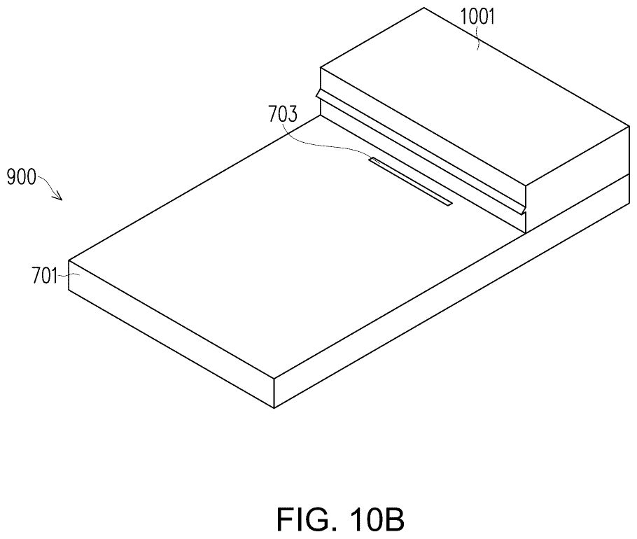

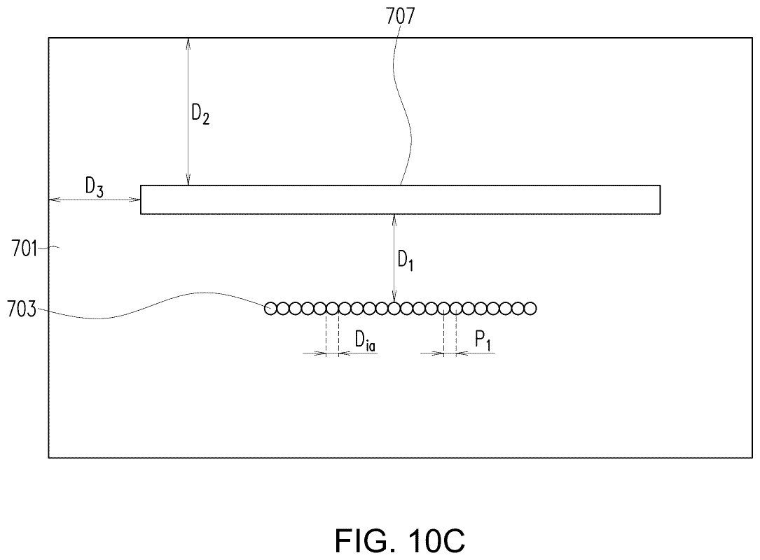

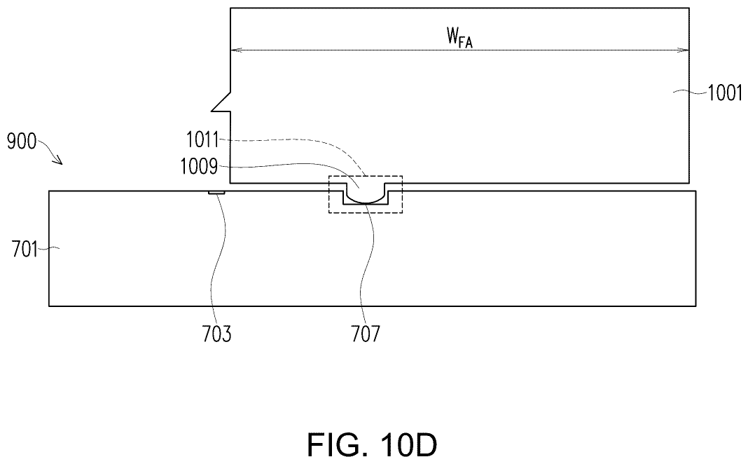

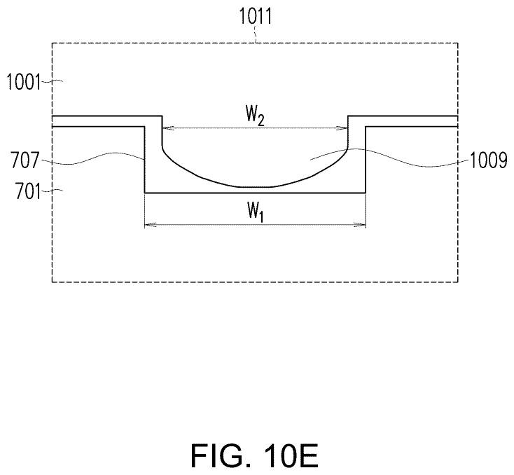

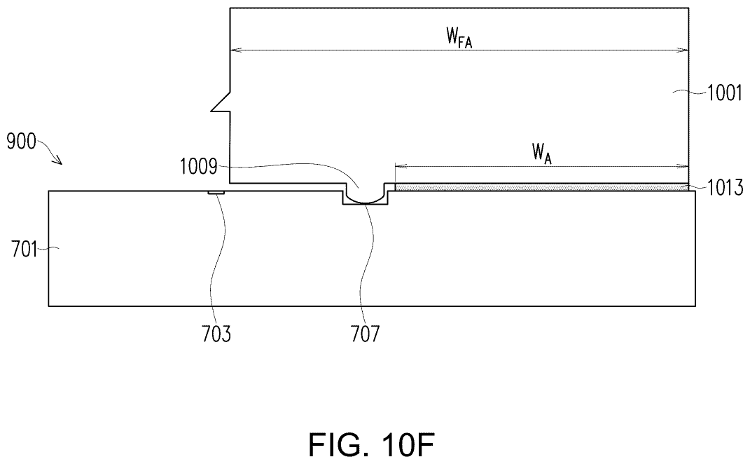

FIG. 7 additionally illustrates that the support substrate 701 comprises a first coupling lens 703 positioned to facilitate movement from a fiber array unit 1001 (not illustrated in FIG. 7 but illustrated and described further below with respect to FIG. 10). In an embodiment the first coupling lens 703 may be formed by shaping the material of the support substrate (e.g., silicon) using masking and etching processes. However, any suitable process may be utilized.

Additionally, if desired, a first anti-reflective coating (ARC) 705 may be formed on the first coupling lens 703. In an embodiment the first ARC 705 may be one or more layers of materials which help to prevent undesired reflections as light is focused through the first coupling lens 703. In a particular embodiment the one or more layers of materials may be materials such as silicon oxide, silicon nitride, combinations of these, or the like, formed using processes such as chemical vapor deposition, atomic layer deposition, physical vapor deposition, oxidation, nitridation, combinations of these, or the like.

In a particular embodiment the first ARC 705 may be formed using a first layer of silicon oxide and a first layer of silicon nitride formed over the first layer of silicon oxide. A second layer of silicon oxide and a second layer of silicon nitride are deposited over the first layer of silicon oxide and the first layer of silicon nitride, forming an alternating stack of silicon oxide and silicon nitride. Once all of the desired layers have been deposited, the layers may be patterned using, e.g., a photolithographic masking and etching process. However, any suitable combinations of materials and processes may be utilized.

Additionally, FIG. 7 also illustrates that the support substrate 701 comprises a first opening 707 positioned to facilitate placement of the fiber array unit 1001. In an embodiment the first opening 707 may be formed by shaping the material of the support substrate (e.g., silicon) using masking and etching processes, either simultaneously with the first coupling lens 703 or separately from the first coupling lens 703. However, any suitable process may be utilized.

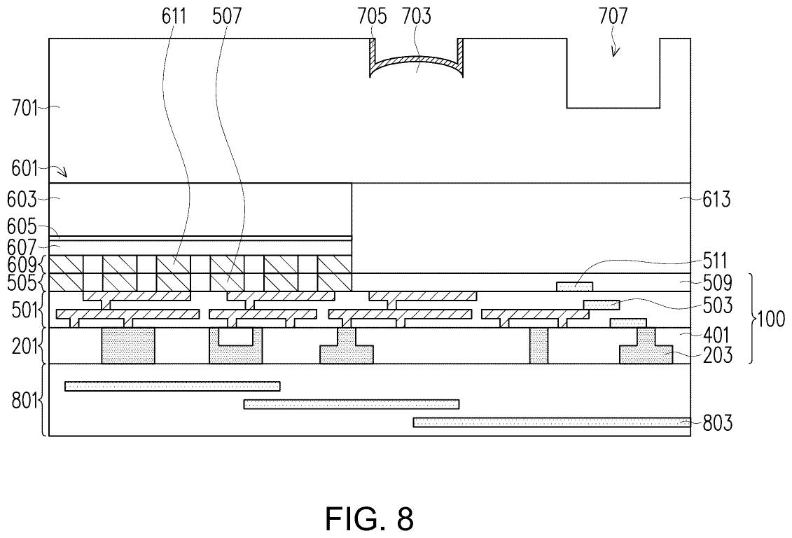

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

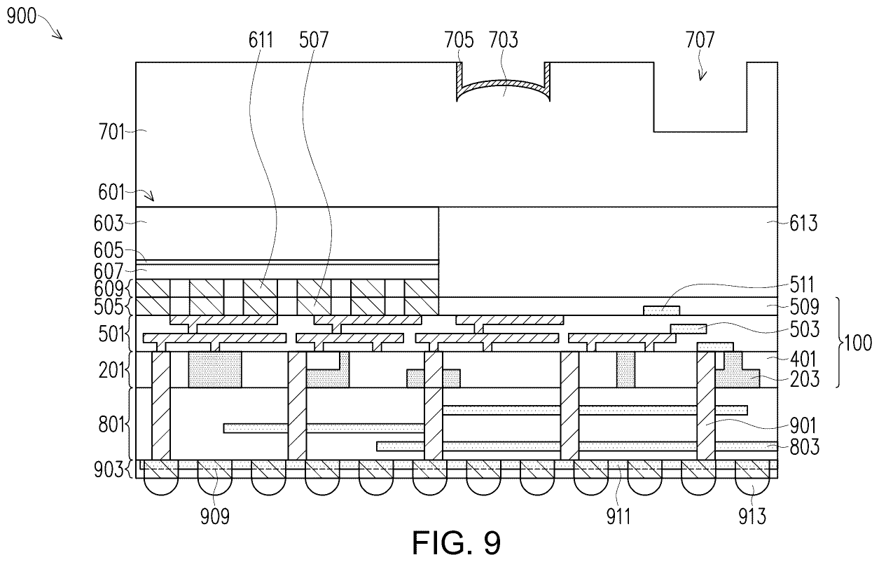

FIG. 9 illustrates formation of first through device vias (TDVs) 901 and formation of a third bonding layer 903 to form a first optical package 900 which, in some embodiments is an optical engine. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

FIG. 9 additionally illustrates a placement of first external connectors 913 which may be formed to provide conductive regions for contact between the third bond pads 909 to other external devices. The first external connectors 913 may be conductive bumps (e.g., C4 bumps, ball grid arrays, microbumps, etc.) or conductive pillars utilizing materials such as solder and copper. In an embodiment in which the first external connectors 913 are contact bumps, the first external connectors 913 may comprise a material such as tin, or other suitable materials, such as silver, lead-free tin, or copper. In an embodiment in which the first external connectors 913 are tin solder bumps, the first external connectors 913 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

Of course, while the use of first external connectors 913 is one embodiment which may be used in order to provide connections for the first optical package 900, this is intended to be illustrative and is not intended to limit the embodiments. Rather, any suitable method of physically, electrically, and in some cases optically connecting the first optical package 900, such as dielectric-to-dielectric and metal-to-metal bonding, may also be utilized. Any suitable method of bonding the first optical package 900 may be used.

FIGS. 10A-10D illustrate varying views of a placement of the fiber array unit 1001 in order to send and receive optical signals 1003 into and out of the first optical package 900. Looking first at FIG. 10A, there is illustrated a very simplified version of the placement of the fiber array unit 1001 over the support substrate 701. In an embodiment the fiber array unit 1001 is a material such as glass that receives optical fibers 1005, arranges the optical fibers 1005 with a fiber sheath, and directs the optical signals 1003 from the optical fibers 1005 towards, e.g., grating couplers within either the first optical components 203, the second optical components 503, or the third optical components 511. The fiber array unit 1001 additionally will receive the optical signals 1003 from the grating couplers and direct the optical signals 1003 to the optical fibers 1005, which will carry the optical signals 1003 away from the device.

Looking next at FIG. 10B, there is illustrated an isometric view of the fiber array unit 1001 being placed and located over the support substrate 701 (with other structures from the first optical package 900 being removed from the figure for clarity). As can be seen in this embodiment, the first coupling lens 703 may be formed in the shape of a single trench in order to receive and direct multiples ones of the optical signals 1003 (not separately illustrated in FIG. 10B) between the fiber array unit 1001 and the first optical package 900.

FIG. 10C illustrates a top down view of a portion of the support substrate 701 with both the first coupling lens 703 and the first opening 707. In this embodiment there are a plurality of the first coupling lens 703 and the first opening 707 is formed to be a single trench. The first opening 707 may be spaced apart from the first coupling lens 703 by a first distance D₁ of about 1 mm. Additionally, the first opening may be spaced from a first die edge a second distance D₂ of about 2 mm and may be spaced from a second die edge a third distance D₃ of about 0.9 mm. However, any suitable distances may be utilized.

Additionally in this view, the first coupling lens 703 may be seen as a series of individual lenses, such as twenty-two lenses aligned in a straight line, although any suitable number may be used. In some embodiments the series of individual lenses may be formed to each have a diameter Dᵢₐ of about 100 μm, and may have a first pitch P1 of about 127 μm, although in other embodiments the individual lenses may each have different dimensions. However, any suitable dimensions may be utilized.

FIG. 10D illustrates a cross-sectional view of the initial placement of the fiber array unit 1001 over the support substrate 701 (with other structures being removed from the figure for clarity), with additional details added. As can be seen in FIG. 10D, the fiber array unit 1001 may have a fiber array width W_{FA}. However, any suitable dimensions may be utilized.

In particular, at this stage an initial passive alignment is provided using a first projection 1009 and the first opening 707. In particular, during the placement of the fiber array unit 1001, the first projection 1009 located on an underside of the fiber array unit 1001 may be placed into the first opening 707 as a way of quickly aligning the fiber array unit 1001 with the remainder of the first optical package 900 and then subsequently constraining the movement of the fiber array unit 1001. In an embodiment the first projection 1009 may be formed integrally with the fiber array unit 1001 or else may be a separate structure that has been attached to the bottom of the fiber array unit 1001.

FIG. 10E illustrates a close-up view of the dashed box labeled 1011 in FIG. 10D, that more closely illustrates the first projection 1009 located within the first opening 707. As can be seen in this cross-sectional figure, the first opening 707 may be formed to have a first width W₁, while the first projection 1009 may be formed to have second width W₂, wherein the first width W₁ is greater than the second width W₂. Additionally, in order to constrain the movement of the fiber array unit 1001 while still allowing for some movement for a more active alignment, the difference between the first width W₁ and the second width W₂ may be about 1.2 times the beam spot diameter of the optical signals 1003 (determined by the processing limitations of the material of the fiber array unit 1001 - e.g., glass). However, any suitable dimensions may be utilized.

Once the initial passive alignment of the fiber array unit 1001 has been performed, an active alignment may be performed in order to find an optimized insertion loss. In particular, the fiber array unit 1001 may be aligned by moving the fiber array unit 1001 (while being constrained by the first projection 1009 within the first opening 707) while measuring the insertion loss of the optical signals 1003 until the insertion loss has been minimized. However, any suitable method of actively aligning the fiber array unit 1001 may be utilized.

Additionally, by providing the initial passive alignment and then restricting the movement of the fiber array unit 1001 to the finite range of movement allowed between the first projection 1009 and the first opening 707, initial, rough parts of the active alignment may be skipped in favor of the later, more finite alignment. As such, the amount of time that is required to actively align the fiber array unit 1001 can be reduced, thereby allowed the units per hour (UPH) of the mating between the fiber array unit 1001 and the first optical package 900 to be improved.

Referring now to FIG. 10F, a first adhesive 1013 is placed between the fiber array unit 1001 and the support substrate 701 in order to hold the fiber array unit 1001 to the first optical package 900 once the fiber array unit 1001 has been placed. In some embodiments, the first adhesive 1013 may be an optical glue that comprises a polymer material such as epoxy-acrylate oligomers, and may have a refractive index between about 1 and about 3. However, any suitable material or other method of attachment may be utilized.

During dispensing, the first adhesive 1013 may be placed between the fiber array unit 1001 and the support substrate 701 using, e.g., an injection process. During placement, the first adhesive 1013 may be squeezed and displaced from its initial location. However, with the presence of the first projection 1009 and the first opening 707 being located between the initial placement of the first adhesive 1013 and the first coupling lens 703, these structures will act as barriers that will hinder the movement of the first adhesive 1013 in that direction, thereby helping to prevent interference and contamination from the first adhesive 1013. As such, while not specifically illustrated in FIG. 10F, the first adhesive 1013 may be in physical contact with the first projection 1009 and may be located within the first opening 707.

Once the first adhesive 1013 and the fiber array unit 1001 have been placed, the first adhesive 1013 may be pre-cured in order to harden the first adhesive 1013. In an embodiment the first adhesive 1013 may be pre-cured with a UV cure. However, any suitable pre-curing process may be utilized.

Once the first adhesive 1013 has been pre-cured, the first adhesive 1013 may be cured in order to further harden the first adhesive 1013 and provide a stronger structure. In an embodiment the first adhesive 1013 may be cured with a baking process. However, any suitable curing process may be utilized.

In an embodiment the first adhesive 1013, after the first adhesive 1013 has been cured, the first adhesive 1013 may have an adhesive width W_{A} that is less than the fiber array width W_{FA}. For example, the adhesive width W_{A} may be between about 0.75 and about 0.85 of the fiber array width W_{FA}. However, any suitable dimensions may be utilized.

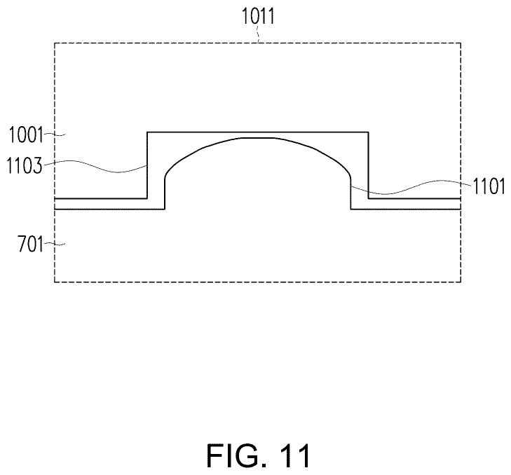

FIG. 11 illustrates another embodiment which provides a passive alignment for placement of the fiber array unit 1001, but which uses a second projection 1101 located on the support substrate 701 and a second opening 1103 located within the fiber array unit 1001. In this embodiment the second projection 1101 may be similar to the first projection 1009 (but located and/or formed on the support substrate 701) while the second opening 1103 may be similar to the first opening 707 (but located and/or formed within the fiber array unit 1001). However, any suitable dimensions may be utilized.

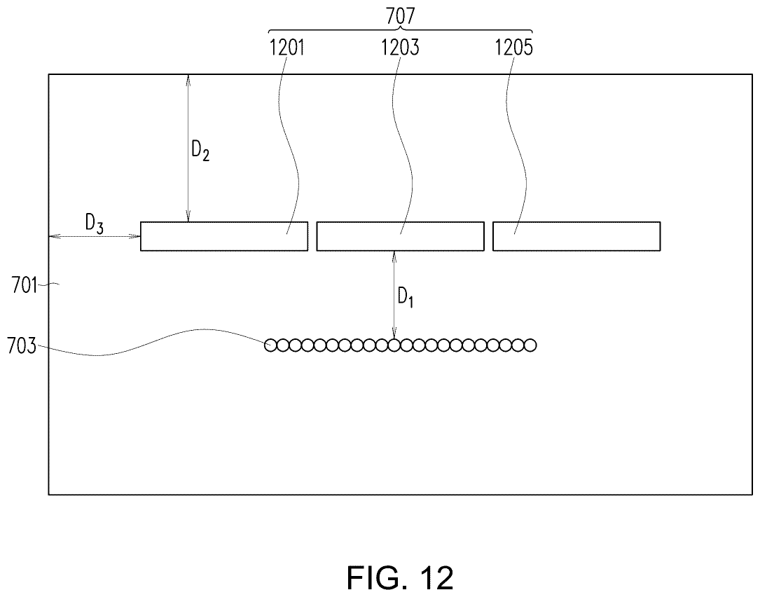

FIG. 12 illustrates another embodiment in which the first opening 707, instead of being shaped as a single trench, is formed as a plurality of trenches, such as a first trench 1201, a second trench 1203, and a third trench 1205 (although any suitable number of trenches may be utilized). In this embodiment the first opening 707 may be distanced as described above with respect to FIG. 10C, with the first distance D₁, the second distance D₂, and the third distance D₃. However, any suitable number of trenches and any suitable distances may be utilized.

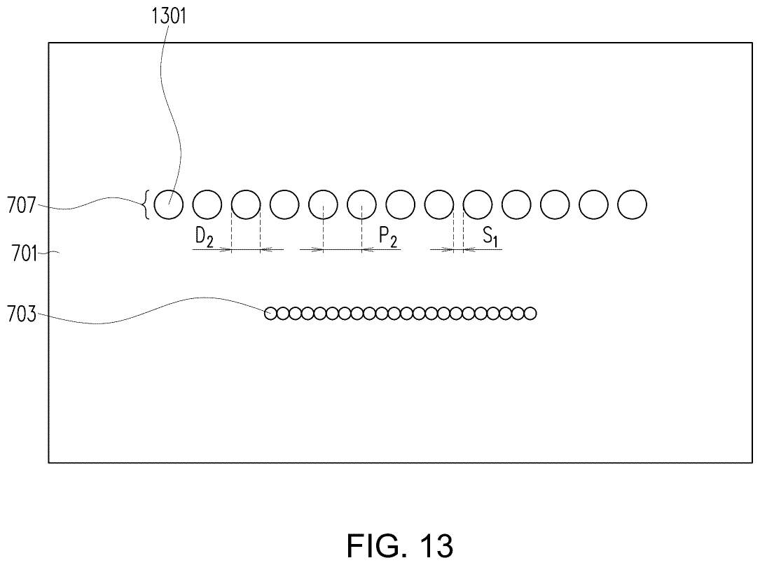

FIG. 13 illustrates yet another embodiment of the first opening 707, in which the first opening 707 is formed as a series of circular openings 1301 instead of one or more trenches. In this embodiment the first opening 707 is formed as a series of circular openings 1301 that are arranged in a line, such as thirteen openings. However, any suitable number of openings may be utilized.

Looking at each one of the circular openings 1301, the circular openings 1301 may each individually have a second diameter D₂ of about 300 μm and may have a first depth of between about 100 μm and about 150 μm. Additionally, the circular openings 1301 may have a second pitch P₂ of about 350 μm and may be spaced apart from each other by a first spacing S₁ that is less than about 20% of the first diameter D₁. However, any suitable dimensions may be utilized.

By utilizing the first projection 1009 and the first opening 707 to provide an initial, passive alignment during placement of the fiber array unit 1001, the time required for the subsequently performed active alignment may be reduced. As such, the units per hour for the active alignment can be improved. Further, the use of the first projection 1009 and the first opening 707 also provides a physical barrier for the undesired movement of the first adhesive 1013 so that the first adhesive 1013 does not interfere with the first coupling lens 703. As such, an overall more efficient process can be obtained.

In an embodiment, a method of manufacturing an optical device includes: attaching a semiconductor die to an optical interposer, the optical interposer comprising at least one waveguide; and attaching a support substrate over the semiconductor die, wherein after the attaching the support substrate the support substrate comprises an alignment opening. In an embodiment the method further includes attaching a fiber array unit to the support substrate, wherein the attaching includes: performing a passive alignment; and after the performing the passive alignment, performing an active alignment. In an embodiment the performing the passive alignment comprises placing a first projection of the fiber array unit into the alignment opening. In an embodiment the alignment opening is a single trench. In an embodiment the alignment opening is one of a series of trenches. In an embodiment the alignment opening is a series of circular openings. In an embodiment the method further includes applying an adhesive between the fiber array unit and the support substrate.

In another embodiment, a method of manufacturing an optical device includes: receiving a first optical package; inserting a first projection into an opening to align a fiber array unit to the first optical package; and after the inserting, actively aligning the fiber array unit with the first optical package. In an embodiment the first projection is part of the fiber array unit. In an embodiment the first projection is part of the first optical package. In an embodiment the opening is a trench. In an embodiment the opening is a plurality of trenches. In an embodiment the plurality of trenches are aligned in a straight line with each other. In an embodiment the opening comprises a plurality of circular openings.

In yet another embodiment an optical device includes: a first optical package; a fiber array unit connected to the first optical package with a projection located within a first opening; and an adhesive located between the first optical package and the fiber array unit. In an embodiment the projection is part of the fiber array unit. In an embodiment the projection is part of the first optical package. In an embodiment the first opening is a single trench. In an embodiment the first opening is a series of trenches. In an embodiment the first opening comprises a series of circular openings.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of manufacturing an optical device, the method comprising:
attaching a semiconductor die to an optical interposer, the optical interposer comprising at least one waveguide; and
attaching a support substrate over the semiconductor die, wherein after the attaching the support substrate the support substrate comprises an alignment opening.

2. The method of claim 1, further comprising attaching a fiber array unit to the support substrate, wherein the attaching comprises:
performing a passive alignment; and
after the performing the passive alignment, performing an active alignment.

3. The method of claim 2, wherein the performing the passive alignment comprises placing a first projection of the fiber array unit into the alignment opening.

4. The method of claim 3, wherein the alignment opening is a single trench.

5. The method of claim 3, wherein the alignment opening is one of a series of trenches.

6. The method of claim 3, wherein the alignment opening is a series of circular openings.

7. The method of claim 3, further comprising applying an adhesive between the fiber array unit and the support substrate.

8. A method of manufacturing an optical device, the method comprising:
receiving a first optical package;
inserting a first projection into an opening to align a fiber array unit to the first optical package; and
after the inserting, actively aligning the fiber array unit with the first optical package.

9. The method of claim 8, wherein the first projection is part of the fiber array unit.

10. The method of claim 8, wherein the first projection is part of the first optical package.

11. The method of claim 8, wherein the opening is a trench.

12. The method of claim 8, wherein the opening is a plurality of trenches.

13. The method of claim 12, wherein the plurality of trenches are aligned in a straight line with each other.

14. The method of claim 8, wherein the opening comprises a plurality of circular openings.

15. An optical device comprising:
a first optical package;
a fiber array unit connected to the first optical package with a projection located within a first opening; and
an adhesive located between the first optical package and the fiber array unit.

16. The optical device of claim 15, wherein the projection is part of the fiber array unit.

17. The optical device of claim 15, wherein the projection is part of the first optical package.

18. The optical device of claim 15, wherein the first opening is a single trench.

19. The optical device of claim 15, wherein the first opening is a series of trenches.

20. The optical device of claim 15, wherein the first opening comprises a series of circular openings.
